(19) United States
(12) Patent Application Publication
(10) Pub. No.: US 2017/0287623 A1
(43) Pub. Date: Oct. 5, 2017

(54) Inductor winding and method for preparing a layout of a Multi-Layer Spiral Inductor winding

(71) Applicant: Xytech Electronic Technology (Shanghai) Co., Ltd., Shanghai (CN)

(72) Inventor: Raphaël Jacques VALENTIN, Shanghai (CN)

(73) Assignee: Xytech Electronic Technology (Shanghai) Co., Ltd., Shanghai (CN)

(21) Appl. No.: 15/470,920

(22) Filed: Mar. 28, 2017

(30) Foreign Application Priority Data
Apr. 1, 2016 (CN) 201610205680.X
Apr. 1, 2016 (CN) 201620271273.4

(51) Int. Cl. H01F 27/28; H01F 41/04; H01F 27/29

(52) U.S. Cl. CPC H01F 27/2804; H01F 27/29; H01F 41/041; H01F 2027/2809

(57) ABSTRACT

A multi-layer spiral inductor winding comprises a plurality of conductive layers, each conductive layer includes a plurality of conductive traces which can be a conductive spiral of at least a fraction of one turn; an additional conductive layer, wherein the additional conductive layer includes a conductive trace, wherein the conductive bridge connects a second terminal electrode of the inductor winding to a conductive trace of the plurality of conductive layers; and wherein a first terminal electrode of the inductor winding belongs to another conductive trace of the plurality of conductive layers; and each distinct conductive trace is electrically connected to each other in order to form a multi-layer spiral inductor winding. The winding may be prepared by adopting a semiconductor process or a PCB process. The winding has the benefits of a high inductance value, a reduced parasitic coupling capacitance, and a high Q-factor.

### CROSS REFERENCE FOR RELATED APPLICATIONS

This application claims priority to Chinese Application number entitled “Coil, Inductor winding and method for preparing a layout of a Multi-Layer Spiral Inductor winding,” with filing number of 201610205680.X filed on Apr. 1, 2016 by Xytech Electronic Technology (Shanghai) Co., Ltd., and “Coil and Inductor device” with filing number of 201620271273.4 filed on Apr. 1, 2016 by Xytech Electronic Technology (Shanghai) Co., Ltd. which are incorporated herein by reference.

### FIELD OF INVENTION

The present invention relates to electronic devices used in an electronic circuit, specifically to an inductor winding and method for preparing a layout of a Multi-Layer Spiral Inductor featuring a high quality-factor and a high self-resonance frequency.

### BACKGROUND

An inductor is a common device in an electronic circuit, and the layout of a spiral inductor used in a semiconductor Integrated Circuit (IC) or in a printed circuit board (PCB) comprises at least a winding of conductive traces. Along with development of the integrated circuit technology, the inductive devices are generally prepared by adopting one conductive layer or a plurality of conductive layers. Because a winding using one conductive layer ordinarily occupies a large chip area, a winding using a plurality of conductive layers can be applied for designing an inductive device. However, inductive devices based on a winding using a plurality of conductive layers have some shortcomings with regards to the self-resonance frequency and the Q-factor.

For example, an inductor device and a preparation method thereof are provided, wherein the inductor structure includes a base material, a plurality of bottom spiral conductors disposed on the base material, at least one top spiral conductor disposed on the at least one bottom spiral conductor, and an insulating material separating the bottom, middle and top spiral conductors, so as to form an inductive winding.

In view of the above, the various spiral stacked inductor winding includes a single or a plurality of conductive loops forming a shape of a coil disposed in a multi-layer sandwich structure. In the multi-layer sandwich structure, each layer generally includes at least one loop. Generally, the plurality of loops of each layer is electrically connected to an underpass contact using metal-filled via holes in the insulating layer.

However, in the conventional multi-layer spiral inductor winding, as shown in FIG. 7, the nested spiral windings disposed on each conductive layer are face-to-face and join together at one endpoint of the inner loops with metal-filled via holes, and the terminal electrodes are located at the endpoints of the outer loops of the upper and lower layers, thereby may affecting the performance of the inductor such as the self-resonance frequency and the Q-factor.

### SUMMARY

An embodiment of the present invention provides a layout used for making an inductor winding featuring high inductance value and jointly having a high self-resonance frequency and a high Q-factor value.

A spiral inductor winding provided in an embodiment of the present invention at least comprises: a plurality of conductive layers, wherein each of the plurality of conductive layers includes a plurality of conductive traces, and wherein each conductive trace is a conductive spiral of at least a fraction of one turn, and wherein at least one conductive trace of the plurality of conductive traces comprises a conductive spiral of two turns; an additional conductive layer, wherein the additional conductive layer includes a conductive trace, wherein the conductive trace is a conductive bridge, wherein the conductive bridge connects a second terminal electrode of the spiral inductor winding to a conductive trace of the plurality of conductive layers; and wherein a first terminal electrode of the inductor winding belongs to another conductive trace of the plurality of conductive layers; and wherein the conductive traces are isolated by an insulating material, and each distinct conductive trace is electrically connected to each other in order to form an inductor winding.

Alternatively, the spiral inductor winding includes a plurality of additional conductive layers instead of an additional conductive layer as described above, wherein each of the plurality of additional layers can include a conductive section trace, each of the conductive section traces is isolated by an insulating material; and wherein the conductive section traces are placed in parallel, respectively; and wherein each conductive section trace is electrically connected to one another using metal-filled via holes in order to form one conductive bridge.

Alternatively, the conductive trace connected to the conductive bridge is an inner conductive trace of the inductor winding and is a spiral of one turn or a fraction of one turn.

Alternatively, the conductive spiral connected to the terminal electrode is an outer conductive spiral of the inductor winding and is a spiral of one turn or a fraction of one turn.

Alternatively, each distinct conductive spiral of the plurality of conductive layers is electrically connected to each other at its one end section or both end sections via metal-filled via holes in order to form an inductor winding.

Therefore, an electrical current passes from a first terminal electrode connected to an outer conductive spiral, flows in the conductive layer of the outer conductive spiral, then follows an alternate path from the conductive layer to its adjacent layer, and flows from the adjacent layer to the adjacent layer of the adjacent layer, and in a manner that the electrical current flows from the outer conductive trace connected to a first terminal electrode to the inner conductive trace connected to the conductive bridge, and flows out of a second terminal electrode connected to the conductive bridge.

Alternatively, the geometric central points of the conductive spirals of the winding are spatially aligned with each other.

Alternatively, the conductive spirals are formed in a shape of square, blended square, octagon, polygon, circle or simple closed curve.

An embodiment of present invention further provides an inductive device comprising: a plurality of inductor windings as describe above, wherein each winding is connected together in series in order to form a single inductive device.

An embodiment of present invention further provides a preparation method of an inductor winding, at least comprising: forming step-by-step the conductive traces of each conductive layer, isolating the conductive traces with one another using an insulating material, forming the multi-layer spiral inductor winding on a substrate, wherein the substrate comprises a semiconductor material, an isolating material or a multi-layer Printed Circuit Board (PCB).

In view of the above embodiments, the inductor winding of an embodiment of the present invention has benefits of a high inductance value, a reduced parasitic coupling capacitance, a high self-resonance frequency, a high Q-factor, and can carry a high level of electrical current.

### BRIEF DESCRIPTION OF THE DRAWINGS

FIG. 1 is a perspective view of an octagonal nine-turn inductor winding layout used for making an octagonal nine-turn spiral inductor in consistency with an embodiment of the present invention.

FIG. 2 shows plan views of the upper layer layout, the upper intermediate layer layout and the lower intermediate layer/bottom layer layout in consistency with the octagonal nine-turn inductor winding of the embodiment shown in FIG. 1.

FIG. 3 shows plan views of the upper layer layout and the intermediate layer/lower layer layout of another octagonal six-turn spiral inductor winding used for making an octagonal six-turn spiral inductor in consistency with the present invention.

FIG. 4 shows plan views of the upper layer layout, the upper intermediate layer layout and the lower intermediate layer/bottom layer layout of another octagonal six-turn spiral inductor winding used for making an octagonal six-turn spiral inductor in consistency with the present invention.

FIG. 5 shows plan views of the upper layer layout and the intermediate layer/lower layer layout of another octagonal eight-turn spiral inductor winding used for making an octagonal eight-turn spiral inductor in consistency with the present invention.

FIG. 6 shows plan views of the upper layer layout and the intermediate layer/lower layer layout of another squared four-turn spiral inductor winding used for making a squared four-turn spiral inductor in consistency with the present invention.

FIG. 7 shows plan views of the upper layer layout and the intermediate layer/lower layer layout of another squared four-turn spiral inductor winding used for making a squared four-turn spiral inductor in consistency with the prior invention.

FIG. 8 shows plan views of the upper layer layout and the intermediate layer/lower layer layout of another squared six-turn spiral inductor winding used for making a squared six-turn spiral inductor in consistency with the present invention.

FIG. 9 shows plan views of the upper layer layout, the upper intermediate layer layout and the lower intermediate layer/bottom layer layout of an octagonal twelve-turn spiral inductor in consistency with the present invention.

FIG. 10 shows plan views of the upper layer layout and the intermediate layer/lower layer layout of another squared twelve-turn spiral inductor in consistency with the present invention.

FIG. 11 shows a schematic view illustrating an electric storage of two adjacent lines electrically connected in series.

FIG. 12 shows the schematic views of the upper layer and the lower layer layout paths used for making a four-turn spiral inductor in consistency with an embodiment the present invention. The schematic view shows the distribution of the potential along the path when the inductor is biased of 1V.

FIG. 13 shows the schematic views of the upper layer and the lower layer layout paths used for making a four-turn spiral inductor in consistency with the conventional technology. The schematic view shows the distribution of the potential along the path when the inductor is biased of 1V.

FIG. 14 is a flow chart illustrating a method of preparing a multi-layer spiral inductor winding in consistency with an embodiment of the invention.

### REFERENCE SIGNS

101, 113,104,110,116,107,119 conductive traces
1011, 1131, 1132, 1041, 1101, 1161, 1071, 1072, 1191 conductive spiral
100, 121 terminal electrodes
102, 103, 105, 106, 108, 109, 111, 112, 114, 115, 117, 118, 120 metal-filled via holes

### DETAILED DESCRIPTION OF EMBODIMENTS

The implementations of an embodiment of the present invention are illustrated through specific embodiments, and those skilled in the art may easily understand other advantages and efficacies of embodiments of the present invention through the content disclosed in the specifications.

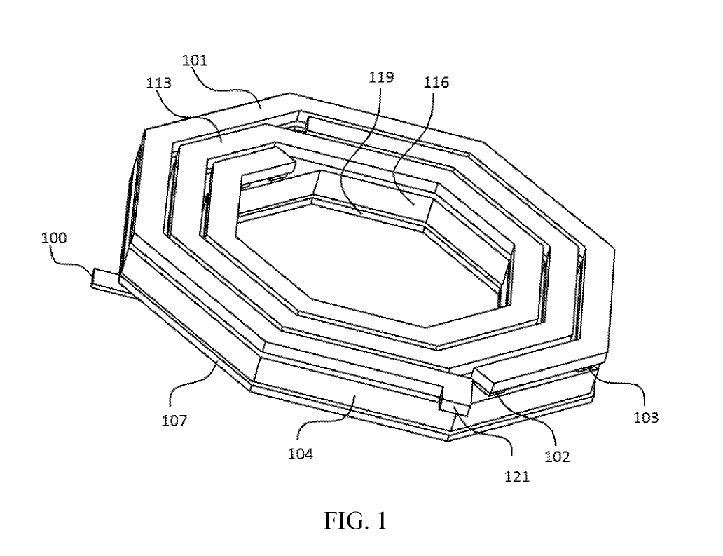

Referring from FIG. 1 to FIG. 13, it should be noted that, the structures, the scales, the sizes, and the like shown in the drawings are only used for illustrative purpose to describe the content disclosed in the specification, so as to ease the understanding and read by persons skilled in the art, instead of limiting implementation of the present invention. Any modification in structure, change in scale, or adjustment in size should fall within the scope of the technical content disclosed by embodiments of the present invention without influencing the generated efficacy of embodiments of the present invention. Meanwhile, some words such as “upper”, “upper-intermediate” “lower-intermediate”, “lower”, “left”, “right”, “middle”, “an”, and “a” as recited in the specification are only used for illustration, instead of limiting the implementation scope of the present invention. Further, any changes or adjustments to relative relationships should be considered as falling within the scope of implementation of an embodiment of the present invention.

An embodiment of the present invention provides a layout used for making an inductor winding featuring high inductance value and a high self-resonance frequency and a high Q-factor value.

A spiral inductor winding provided in an embodiment of the present invention at least comprises: a plurality of conductive layers, wherein each of the plurality of conductive layers includes a plurality of conductive traces, and wherein each conductive trace is a conductive spiral of one turn or two turns or a fraction of one turn, and wherein at least one conductive trace is a conductive spiral of two turns; an additional conductive layer, wherein the additional conductive layer includes a conductive trace, wherein the conductive trace is a conductive bridge, wherein the conductive bridge is configured to connect a second terminal electrode of the spiral inductor winding to a conductive trace of the plurality of conductive layers; and wherein a first terminal electrode of the inductor winding belongs to another conductive trace of the plurality of conductive layers; and wherein the conductive traces are isolated by an insulating material, and each distinct conductive trace is electrically connected to one another in order to form an inductor winding. Alternatively, the spiral inductor winding includes a plurality of additional conductive layers instead of an additional conductive layer as described above, wherein each of the plurality of additional layers includes a conductive section trace, each of the conductive section traces is isolated by an insulating material; and wherein the conductive section traces are placed in parallel, respectively; and wherein each conductive section trace is electrically connected to one another using metal-filled via holes in order to form one conductive bridge.

An embodiment of the present invention further provides an inductive device comprising: a plurality of inductor windings as described above, wherein each winding is connected together in series in order to form a single inductive device.

An embodiment of the present invention further provides a preparation method of an inductor winding, at least comprising: forming step-by-step the conductive traces of each conductive layer, isolating the conductive traces with one another through an insulating material, forming the multi-layer spiral inductor winding on a substrate, wherein the substrate comprises a semiconductor material, an isolating material or a multi-layer Printed Circuit Board (PCB).

In view of the above, the inductor winding of an embodiment of the present invention has the benefits of a high inductance value, a reduced parasitic coupling capacitance, a high self-resonance frequency, a high Q-factor, and carries a high level of electrical current. The spiral inductor winding of an embodiment of the present invention may be used for making multi-layer spiral inductor devices, and below illustrations are presented respectively such as some examples of spiral inductor windings.

### Embodiment 1

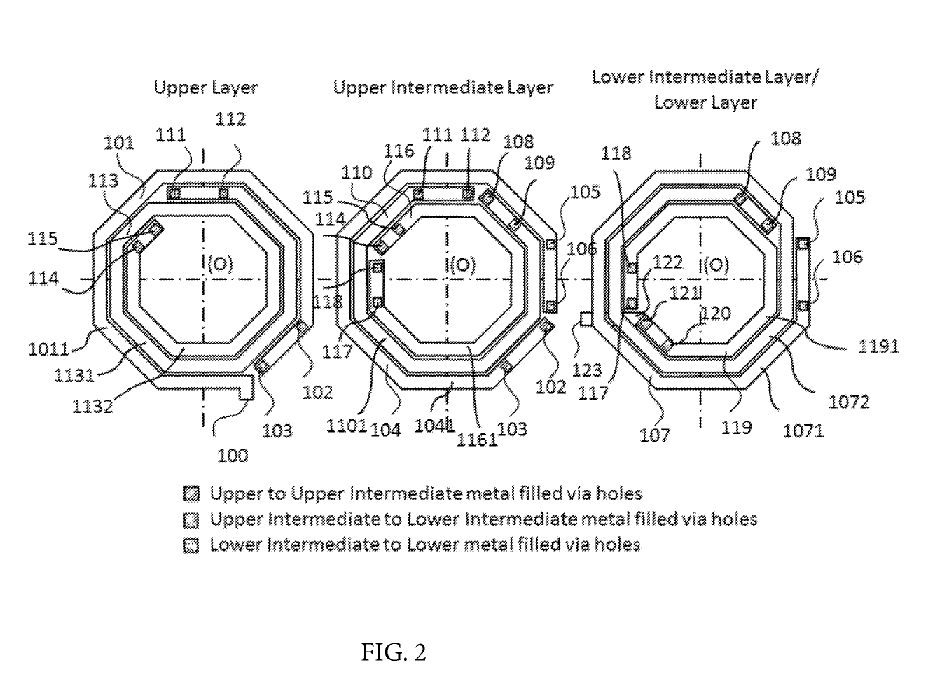

An embodiment of the present invention will now be described with reference to the accompanying drawings. FIG. 1 shows the perspective view of an embodiment of the present invention. FIG. 2 shows plan views of the upper layer, the upper-intermediate layer, the lower-intermediate layer and the lower layer of the spiral inductor winding as shown in FIG. 1 at the left, middle and right sides respectively. For each layout plan view, the inductor includes a plurality of metal-filled via holes used for connecting a conductive trace of a layer to another conductive trace of its adjacent layer.

The spiral inductor winding according to an embodiment comprises in total four conductive layers, namely, the upper layer, the upper-intermediate layer, the lower-intermediate layer, and the lower layer. The upper layer includes two conductive traces 101, 113. The outer conductive trace 101 comprises the conductive spiral loop 1011 as shown in FIG. 2, that is, the outer conductive trace 101 is a conductive spiral of one turn. The inner conductive trace 113 comprises two distinct conductive spiral loops 1131, 1132 as shown in FIG. 2, that is, the inner conductive trace 113 is a conductive spiral of two turns. The upper-intermediate layers includes three conductive traces 104, 110, 116. The outer conductive trace 104 comprises a conductive spiral loop 1041 as shown in FIG. 2, that is, the outer conductive trace 104 is a conductive spiral of one turn. The middle conductive trace 110 comprises a conductive spiral loop 1101 as shown in FIG. 2, that is, the middle conductive trace 110 is a conductive spiral of one turn. The inner conductive trace 116 comprises a conductive spiral loop 1161 as shown in FIG. 2, that is, the inner conductive trace 116 is a spiral of one turn. The lower-intermediate layers includes two conductive traces 107 and 119. The outer conductive trace 107 comprises two distinct conductive spiral loops 1071 and 1072 as shown in FIG. 2, that is, the outer conductive trace 107 is a spiral of two turns. The inner conductive trace 119 comprises a conductive spiral loop 1191 as shown in FIG. 2, that is, the inner conductive trace 119 is a spiral of one turn. The conductive traces are isolated with each other by an insulating material. The term “loop” used in the specification may represent turns of a same spiral or turns of different spirals. For example, as shown in FIG. 2, loops 1131 and 1132 are turns of the same spiral. Alternatively, loops 1161 and 1101 in FIG. 2 belong to separated and distinct spirals.

The three conductive spiral loops 1011, 1131 and 1132 of the upper layer have the same shape but different radius sizes, and are in a nested manner; the 3 conductive spiral loops 1041, 1101, 1161 of the upper-intermediate layer have the same shape but different radius sizes, and are in a nested manner. The three conductive spiral loops 1071, 1072, 1191 of the lower-intermediate layer have the same shape but different radius sizes, and are in a nested manner. Finally, the lower layer contains a conductive trace, and the conductive trace is the conductive bridge 120 that connects the inner conductive trace 119 (that is, the inner conductive spiral loop 1191) of the lower-intermediate layer to a second terminal electrode 121. The conductive spiral loops are all in octagonal shape. The inductor winding comprises in total 9 turns; also, for the 3 adjacent layers, the lateral spacing between two adjacent conductive spiral loops is the same for each layer.

Alternatively, the lower conductive layer can be replaced with a plurality of additional conductive layers, each of the plurality of additional layers includes a conductive section trace, and each conductive section trace are isolated by an insulating material and are placed in parallel, such that each conductive section trace is electrically connected to one another using metal-filled via holes in order to form the conductive bridge, therefore the series resistance can be greatly reduced. The outer conductive spiral loop 1011 of the upper layer is in face-to-face with the outer conductive spiral loop 1041 of the upper-intermediate layer which is in face-to-face with the outer conductive spiral loop 1071 of the lower-intermediate layer; the middle conductive spiral loop 1131 of the upper layer is in face-to-face with the middle conductive spiral loop 1101 of the upper-intermediate layer which is in face-to-face with the middle conductive spiral loop 1072 of the lower-intermediate layer; the inner conductive spiral loop 1132 of the upper layer is in face-to-face with the inner conductive spiral loop 1161 of the upper-intermediate layer which is in face-to-face with the inner conductive spiral loop 1191 of the lower intermediate layer. Thus, the geometric center points of all the spiral conductive spiral loops (O) are spatially aligned with each other; the outer spiral loop 1011, 1041, 1071 share the same shape and radius size, the middle spiral loop 1131, 1101, 1072 share the same shape and radius size, the inner spiral loop 1131, 1161, 1191 share the same shape and radius size.

Each conductive trace of one layer is electrically connected to the conductive trace of its adjacent layer at its one end section or two end sections using a pair of metal-filled via holes. A first end section and/or a last end section of each conductive trace of one layer are connected to a first end section and/or a last end section of each conductive trace of its adjacent conductive layers using a pair of metal-filled via holes.

For example, the first end section of the outer conductive trace 101 of the upper layer is connected to the first terminal electrode 100. Note the first conductive trace that connects the terminal electrode 100 can also be called as a bridge, as it crosses at least one loop. The last end section of the inner conductive trace 119 of the lower-intermediate layer is connected to the second terminal electrode 123 via the conductive bridge 122 located in the lower layer.

The last end section of the outer conductive trace 101 of the upper layer is connected with the first end section of the outer conductive trace 104 of the upper-intermediate layer via a pair of metal-filled via holes 102 and 103. The last end section of the outer conductive trace 104 of the upper-intermediate layer is connected with the first end section of the outer conductive trace 107 of the lower-intermediate layer via a pair of metal-filled via holes 105 and 106. The last end section of the outer conductive trace 107 of the lower-intermediate layer is connected with the first end section of the middle conductive trace 110 of the upper-intermediate layer via a pair of metal-filled via holes 108 and 109. The last end section of the middle conductive trace 110 of the upper-intermediate layer is connected with the first end section of the inner conductive trace 113 of the upper layer via a pair of metal-filled via holes 111 and 112. The last end section of the inner conductive trace 113 of the upper layer is connected with the first end section of the inner conductive trace 116 of the upper-intermediate layer via a pair of metal-filled via holes 114 and 115. Finally, the last end section of the inner conductive trace 116 of the upper-intermediate layer is connected with the first end section of the inner conductive trace 119 of the lower-intermediate layer via a pair of metal-filled via holes. The last end section of the second conductive trace 119 of the lower-intermediate layer is electrically connected with the conductive bridge 122 via a pair of metal-filled via holes 120 and 121.

Therefore, an electrical current passes the first terminal electrode 100, flows through the outer conductive trace 101 of the upper layer (the outer conductive spiral loop 1011), through a pair of metal-filled via holes 102 and 103, through the outer conductive trace 104 of the upper-intermediate layer (the outer conductive spiral loop 1041), through a pair of metal-filled via holes 105 and 106, through the outer conductive trace 107 of the lower-intermediate layer (the outer conductive spiral loop and the middle conductive spiral loop 1071, 1072), through a pair of metal-filled via holes 108 and 109, through the middle conductive trace 110 of the upper-intermediate layer (the middle conductive spiral loop 1101), through a pair of metal-filled via holes 111 and 112, through the inner conductive trace 113 of the upper layer (the middle conductive spiral loop and the inner conductive spiral loop 1131 and 1132), through a pair of metal-filled via holes 114 and 115, through the inner conductive trace 116 of the upper-intermediate layer (the inner conductive spiral loop 1161), through a pair of metal-filled via holes 117 and 118, through the inner conductive trace 119 of the lower-intermediate layer (the inner conductive spiral loop 1191), through a pair of metal-filled via holes 120 and 121, finally through the conductive bridge 122 located in the lower layer, and flows out of the second terminal electrode 123. The winding may be used for making an inductor device and the like.

In this embodiment, the cross-sections of the pairs of metal-filled via holes do not exceed the width of the conductive trace.

Alternatively, the conductive traces 101, 119 can be a conductive spiral of a fraction of one turn in order to meet the layout requirements concerning the location of each terminal electrode.

### Embodiment 2

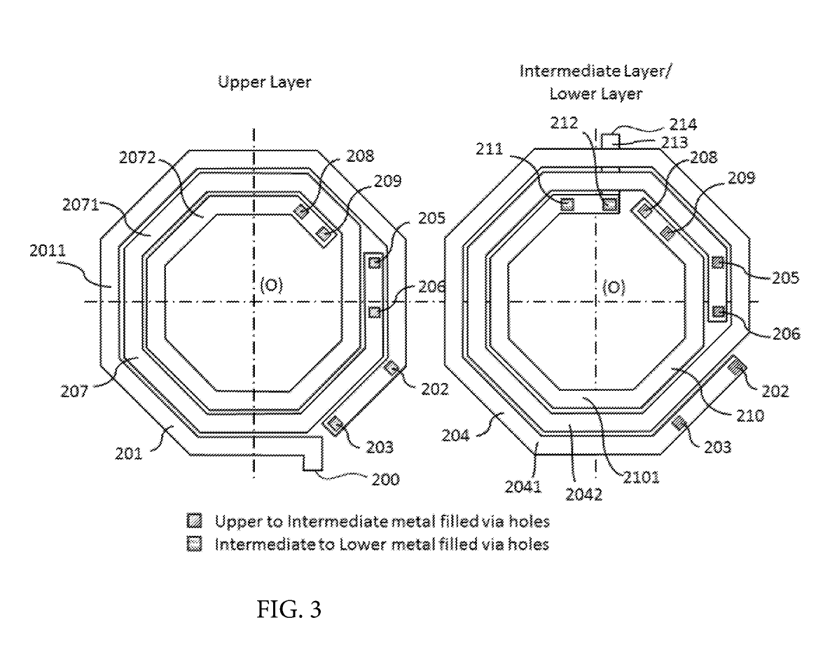

FIG. 3 shows plan views of the upper layer, the intermediate layer and the lower layer of the inductor winding at the left and right sides, respectively according to an embodiment of the present invention. For each layout plan view, it includes the metal-filled via holes used for connecting a conductive trace of a layer to another conductive trace of its adjacent layer.

The inductor winding device comprises 3 conductive layers in total named the upper layer, the intermediate layer and the lower layer. The upper layer includes two conductive traces 201 and 207. The outer conductive trace 201 comprises a conductive spiral loop 2011, that is, the outer conductive trace 201 is a conductive spiral of one turn. The inner conductive trace 207 comprises two conductive spiral loops 2071 and 2072, that is, the inner conductive trace 207 is a conductive spiral of two turns. The intermediate layer includes two conductive traces 204 and 210. The outer conductive trace 204 comprises two conductive spiral loops 2041 and 2042, that is, the outer conductive trace 204 is a conductive spiral of two turns. The inner conductive trace 210 comprises a conductive spiral loop 2101, that is, the inner conductive trace 210 is a conductive spiral of one turn. The three conductive spiral loops 2011, 2071 and 2072 of the upper layer have the same shape but different radius sizes, and are in a nested manner. The three conductive spiral loops 2041, 2042 and 2101 of the intermediate layer have the same shape but different radius sizes, and are in a nested manner. Finally, the lower layer contains a conductive bridge 213 that connects the inner conductive trace 210 (that is, the conductive spiral loop 2101) of the intermediate layer to a second terminal electrode 213. The conductive spiral loops are all in octagonal shape. The inductor winding comprises in total 6 turns. The conductive traces are isolated with each other by an insulating material. Further, for the 3 adjacent layers, the lateral spacing between two adjacent spiral loops is the same for each layer.

The outer conductive spiral loop 2011 of the upper layer is in face-to-face with the outer conductive spiral loop 2041 of the intermediate layer. The middle conductive spiral loop 2071 of the upper layer is in face-to-face with the middle conductive spiral loop 2042 of the intermediate layer. The inner conductive spiral loop 2072 is face-to-face with the inner conductive spiral loop 2101 of the intermediate layer. Thus, the geometric center points of all the conductive spiral loops (O) are spatially aligned with each other.

Each conductive trace of one layer is electrically connected to the conductive trace of its adjacent layer using a pair of metal-filled via holes. A first end section and/or a last end section of each conductive trace of one layer are connected to a first end section and/or a last end section of each conductive trace of its adjacent conductive layers using a pair of metal-filled via holes.

For example, the first end section of the outer conductive trace 201 of the upper layer is connected to the first terminal electrode 200. The last end section of the inner conductive trace 210 of the intermediate layer is connected to the second terminal electrode 214 via the conductive bridge 213 located in the lower layer.

The last end section of the outer conductive trace 201 of the upper layer is connected with the first end section of the outer conductive trace 204 of the intermediate layer via a pair of metal-filled via holes 202 and 203. The last end section of the outer conductive trace 204 of the intermediate layer is connected with the first end section of the inner conductive trace 207 of the upper layer via a pair of metal-filled via holes 205 and 206. The last end section of the inner conductive trace 207 of the upper layer is connected with the first end section of the inner conductive trace 210 of the intermediate layer via a pair of metal-filled via holes 208 and 209. The last end section of the second conductive trace 210 of the intermediate layer is electrically connected with the conductive bridge 213.

Therefore, an electrical current flows from the first terminal electrode 200, flows through the outer conductive trace 201 of the upper layer (the outer spiral loop 2011), through a pair of metal-filled via holes 202, 203, through the outer conductive trace 204 of the intermediate layer (the outer spiral loop and middle spiral loop 2041, 2042), through a pair of metal-filled via holes 205, 206, through the inner conductive trace 207 of the upper layer (the middle spiral loop and inner spiral loop 2071, 2072), through a pair of metal-filled via holes 208, 209, through the inner conductive trace 210 of the intermediate layer (the inner spiral loop 2101), through a pair of metal-filled via holes 211, 212, finally through the conductive bridge 122 located in the lower layer, and flows out of the second terminal electrode 124. The winding may be used for making an inductor device and the like.

### Embodiment 3

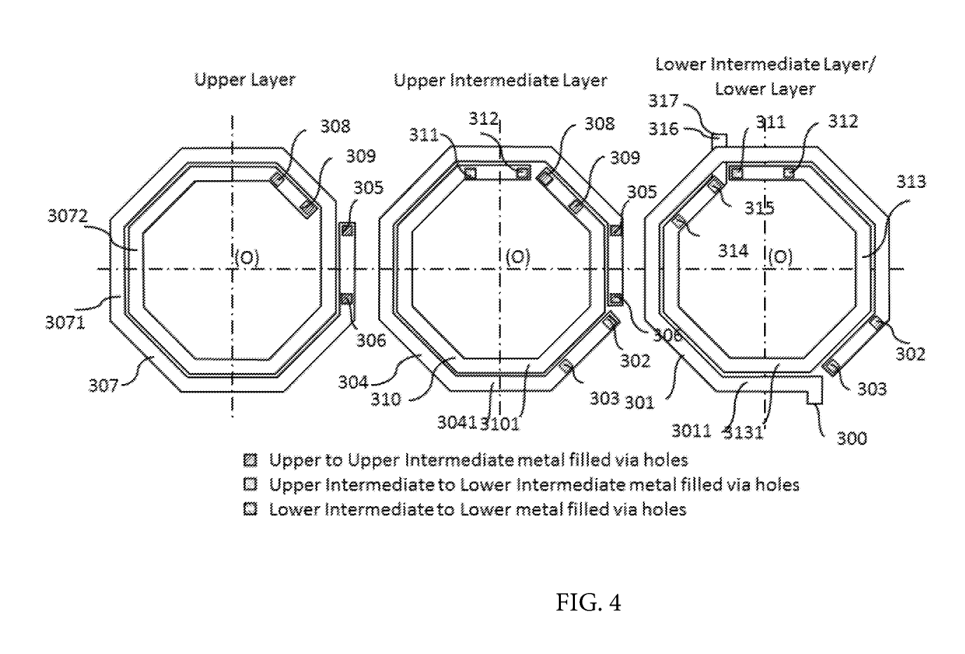

FIG. 4 shows plan views of the upper layer, the upper-intermediate layer, the lower-intermediate layer and the lower layer of the inductor winding at the left, middle and right sides, respectively. For each layout plan view, the inductor winding includes the metal-filled via holes used for connecting a conductive trace of a layer to another conductive trace of its adjacent layer.

The inductor winding device comprises in total four conductive layers named the upper layer, the upper-intermediate layer, lower-intermediate layer, and lower layer. The upper layer includes a conductive trace 307. The conductive trace 307 comprises two conductive spiral loops 2071, 2072, that is, the conductive trace 307 is a conductive spiral of two turns; the upper-intermediate layers includes two conductive traces 304 and 310. The outer conductive trace 304 comprises a conductive spiral loop 3041, that is, the outer conductive trace 304 is a conductive spiral of one turn. The inner conductive trace 310 comprises a conductive spiral loop 3101, that is, the inner conductive trace 310 is a conductive spiral of one turn. The lower-intermediate layer includes two conductive traces 301 and 313. The outer conductive trace 301 comprises one conductive spiral loops 3011, that is, the outer conductive trace 301 is a conductive spiral of one turn. The inner conductive trace 313 comprises a conductive spiral loop 3131, that is, the inner conductive trace 313 is a spiral of one turn.

The two conductive spiral loops 3071 and 3072 of the upper layer have the same shape but different radius sizes, and are in a nested manner. The two conductive spiral loops 3041 and 3101 of the upper-intermediate layer have the same shape but different radius sizes, and are in a nested manner. The two conductive spiral loops 3011 and 3131 of the lower-intermediate layer have the same shape but different radius sizes, and are in a nested manner. Finally, the lower layer contains a conductive bridge 316 that connects the conductive trace 313 (that is, the conductive spiral loop 3131) of the lower-intermediate layer to a second terminal electrode 317. The conductive spiral loops are all in octagonal shape. The inductor winding comprises in total 6 turns. Further, for the 3 adjacent layers, the spacing between two lateral adjacent spiral loops is the same for each layer.

Further, the outer conductive spiral loop 3071 of the upper layer is in face-to-face with the outer conductive spiral loop 3041 of the upper-intermediate layer which is in face-to-face with the outer conductive spiral loop 3011 of the lower-intermediate layer. The inner conductive spiral loop 3072 of the upper layer is in face-to-face with the inner conductive spiral loop 3101 of the upper-intermediate layer which is in face-to-face with the inner conductive spiral loop 3131 of the lower-intermediate layer. Thus, the geometric center points of all the conductive spiral loops (O) are spatially aligned with each other. The outer conductive spiral loops 3071, 3041 and 3011 share the same shape and radius sizes. The inner conductive spiral loops 3072, 3101 and 3131 share the same shape and radius sizes.

Each conductive traces of one layer is electrically connected to the conductive trace of its adjacent layer using a pair of metal-filled via holes. A first end section and/or a last end section of each conductive trace of one layer are connected to a first end section and/or a last end section of each conductive trace of its adjacent conductive layers via the metal-filled via holes.

The first end section of the conductive trace 301 of the upper layer is connected to the first terminal electrode 300. The last end section of the inner conductive trace 313 of the lower-intermediate layer is connected to the second terminal electrode 317 via the conductive bridge 316 located in the lower layer.

For each conductive trace, either or both end sections, that is to say, the first or the last end section of the conductive trace are used to interconnect each conductive trace of one layer to the conductive trace of its adjacent layers via a pair of metal-filled via holes. Thus, the last end section of the outer conductive trace 301 of the lower-intermediate layer is connected with the first end section of the outer conductive trace 304 of the upper-intermediate layer via a pair of metal-filled via holes 302 and 303. The last end section of the outer conductive trace 304 of the upper-intermediate layer is connected with the first end section of the conductive trace 307 of the upper layer via a pair of metal-filled via holes 305 and 306. The last end section of the conductive trace 307 of the upper layer is connected with the first end section of the inner conductive trace 310 of the upper-intermediate layer via a pair of metal-filled via holes 308 and 309. The last end section of the inner conductive trace 310 of the upper-intermediate layer is connected with the first end section of the inner conductive trace 313 of the lower-intermediate layer via a pair of metal-filled via holes 311 and 312. The last end section of the inner conductive trace 313 of the lower-intermediate layer is electrically connected with the conductive bridge 316.

Therefore, an electrical current flows from the first terminal electrode 300, through the outer conductive trace 301 of the lower-intermediate layer (the outer conductive spiral loop 3011), through a pair of metal-filled via holes 302, 303, through the outer conductive trace 304 of the upper-intermediate layer (the outer conductive spiral loop 3041), through a pair of metal-filled via holes 305 and 306, through the conductive trace 307 of the upper layer (the outer conductive spiral loop and the inner conductive spiral loops 3071 and 3072), through a pair of metal-filled via holes 308, 309, through the inner conductive trace 310 of the upper-intermediate layer (the inner conductive spiral loop 3101), through a pair of metal-filled via holes 311 and 312, through the inner conductive trace 313 of the lower layer (the inner conductive spiral loop 3131), through a pair of metal-filled via holes 314 and 315, finally through the conductive bridge 316 located in the lower layer, and flows out of the second terminal electrode 317. The winding may be used for making an inductor device and the like.

In this embodiment, the cross-sections of the pairs of metal-filled via holes do not exceed the width a conductive trace.

### Embodiment 4

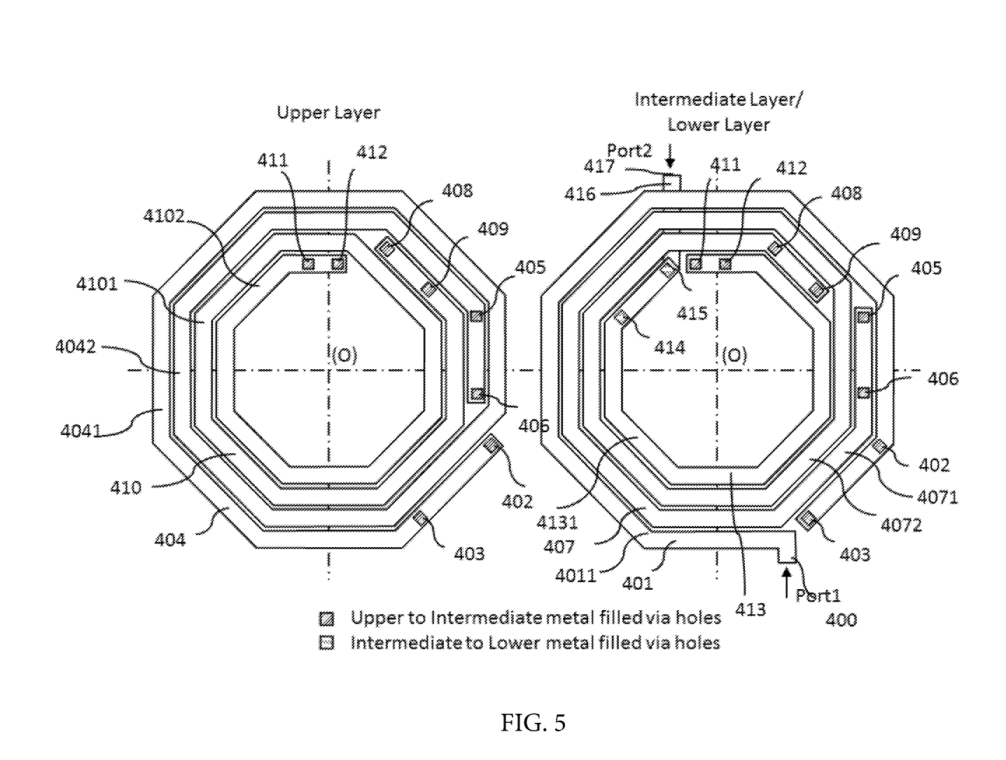

FIG. 5 shows plan views of the upper layer, the intermediate layer and the lower layer of the inductor winding at the left and right sides, respectively according to an embodiment. For each layout plan view, it includes the metal-filled via holes used for connecting a conductive trace of a layer to another conductive trace of its adjacent layer.

The inductor winding device comprises in total three conductive layers, named the upper layer, the intermediate layer, and the lower layer. The upper layer includes two conductive traces 404, 410. The outer conductive trace 404 comprises two conductive spiral loops 4041 and 4042, that is, the outer conductive trace 404 is a conductive spiral of two turns. The inner conductive trace 410 comprises two conductive spiral loops 4101 and 4102, that is, the inner conductive trace 410 is a spiral of two turns. The intermediate layer includes three conductive traces 401, 407 and 413. The outer conductive trace 401 comprises a conductive spiral loop 4011, that is, the outer conductive trace 401 is a conductive spiral of a turn. The middle conductive trace 407 comprises two spiral loops 4071 and 4072, that is, the middle conductive trace 407 is a conductive spiral of two turns. The inner conductive trace 413 comprises a conductive spiral loop 4131, that is, the conductive trace 413 is a conductive spiral of one turn. The four conductive spiral loops 4041, 4042, 4101 and 4102 of the upper layer have the same shape but different radius sizes, and are in a nested manner. The 4 conductive spiral loops 4011, 4071 and 4072 of the intermediate layer have the same shape but different radius sizes, and are in a nested manner. Finally, the lower layer contains a conductive bridge 416 that connects the conductive trace 413 (that is, the inner conductive spiral loop 4131) of the intermediate layer to a second terminal electrode 414. The conductive spiral loops are all in octagonal shape. The inductor winding comprises in total eight turns. Further, for the three adjacent layers, the lateral spacing between two adjacent spiral loops is the same for each layer.

The outer conductive spiral loop 4041 of the upper layer is in face-to-face with the outer conductive spiral loop 4011 of the intermediate layer. The outer-middle conductive spiral loop 4042 of the upper layer is in face-to-face with the outer-middle conductive spiral loop 4071 of the intermediate layer. The inner-middle conductive spiral loop 4101 of the upper layer is in face-to-face with the inner-middle conductive spiral loop 4072 of the intermediate layer. The inner conductive spiral loop 4102 is in face-to-face with the inner conductive spiral loop 4131 of the intermediate layer. Thus, the geometric center points of all the conductive spiral loops (O) are spatially aligned with each other.

Each of conductive traces of one layer is electrically connected to the conductive trace of its adjacent layer using a pair of metal-filled via holes. A first end section and/or a last end section of each conductive trace of one layer are connected to a first end section and/or a last end section of the conductive trace of its adjacent conductive layers using a pair of metal-filled via holes, or connected to the terminal electrode via the conductive bridge.

The first end section of the outer conductive trace 401 of the intermediate layer is connected to the first terminal electrode 400. The last end section of the inner conductive trace 413 of the intermediate layer is connected to the second terminal electrode 417 via the conductive bridge 416 located in the lower layer.

For each conductive trace, one or two end sections, that is to say, the first or the last end section of the conductive trace are used to interconnect each conductive trace of one layer to the conductive trace of its adjacent layers via a pair of metal-filled via holes. Thus, the last end section of the outer conductive trace 401 of the intermediate layer is connected with the first end section of the outer conductive trace 404 of the upper layer via a pair of metal-filled via holes 402 and 403. The last end section of the outer conductive trace 404 of the upper layer is connected with the first end section of the middle conductive trace 407 of the intermediate layer through a pair of metal-filled via holes 405 and 406. The last end section of the second conductive trace 407 of the intermediate layer is connected with the first end section of the second conductive trace 410 of the upper layer through a pair of metal-filled via holes 408 and 409. The last end section of the second conductive trace 410 of the upper layer is connected with the first end section of the third conductive trace 413 of the intermediate layer through a pair of metal-filled via holes 411 and 412. The last end section of the third conductive trace 413 of the intermediate layer is electrically connected with the conductive bridge 416.

Therefore, an electrical current that has accessed from the first terminal electrode 400 flows through the first conductive trace 401 of the intermediate layer (the outer conductive spiral loop 4011), through a pair of metal-filled via holes 402 and 403, through the outer conductive trace 404 of the upper layer (the outer conductive spiral loop 4041 and the outer-middle conductive spiral loop 4042), through a pair of metal-filled via holes 405, 406, through the middle conductive trace 407 of the intermediate layer (the outer-middle conductive spiral loop 4071 and inner-middle conductive spiral loop 4072), through a pair of metal-filled via holes 408 and 409, through the inner conductive trace 410 of the upper layer (the inner-middle conductive spiral loop 4101 and the inner conductive spiral loop 4102), through a pair of metal-filled via holes 411 and 412, through the inner conductive trace 413 of the intermediate layer (the inner conductive spiral loop 4131), through a pair of metal-filled via holes 414 and 415, finally through the conductive bridge 416 located in the lower layer, and flows out of the second terminal electrode 417. The winding may be used for making an inductor device and the like.

In this embodiment, the cross-sections of the pairs of metal-filled via holes dos not exceed the width a conductive trace.

### Embodiment 5

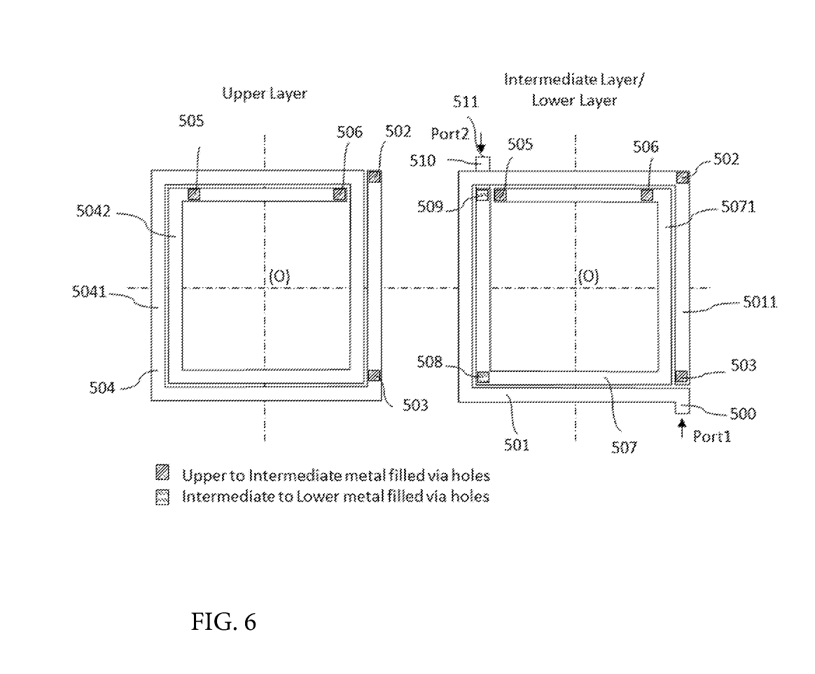

FIG. 6 shows plan views of the upper layer, the intermediate layer and the lower layer of the inductor winding at the left and right sides, respectively according to an embodiment. For each layout plan view, it includes the metal-filled via holes used for connecting a conductive trace of a layer to another conductive trace of its adjacent layer.

The inductor winding device comprises in total three conductive layers named the upper layer, the intermediate layer and the lower layer. The upper layer includes a conductive trace 504. The conductive trace 504 comprises two conductive spiral loops 5041 and 5042, that is, the conductive trace 504 is a conductive spiral of two turns. The intermediate layer includes two conductive traces 501 and 507. The outer conductive trace 501 comprises a conductive spiral loop 5011, that is, the outer conductive trace 501 is a conductive spiral of one turn. The inner conductive trace 507 comprises a conductive spiral loop 5071, that is, the inner conductive trace 507 is a conductive spiral of one turn.

The two conductive spiral loops 5041, 5042 of the upper layer have the same shape but different radius sizes, and are in a nested manner. The two conductive spiral loops 5011 and 5071 of the intermediate layer have the same shape but different radius sizes, and are in a nested manner. Finally, the lower layer contains a conductive bridge 510 that connects the inner conductive trace 507 (that is, the inner conductive spiral loop 5071) of the intermediate layer to a second terminal electrode 511. The conductive spiral loops are all in square shape. The inductor winding comprises in total four turns. Further, for the three adjacent layers, the lateral spacing between two adjacent spiral loops is the same for each layer.

The outer conductive spiral loop 5041 of the upper layer is in face-to-face with the outer conductive spiral loop 5011 of the intermediate layer. The inner conductive spiral loop 5042 of the upper layer is in face-to-face with the inner conductive spiral loop 5071 of the intermediate layer. Thus, the geometric center points of all the conductive spiral loops (O) are spatially aligned with each other.

Each conductive trace of one layer is electrically connected to the conductive trace of its adjacent layer using a pair of metal-filled via holes. A first end section and/or a last end section of each conductive trace of one layer are connected to a first end section and/or a last end section of the conductive trace of its adjacent conductive layers using a pair of metal-filled via holes, or connected to the terminal electrode via the conductive bridge.

The first end section of the outer conductive trace 501 of the intermediate layer is connected to the first terminal electrode 200. The last end section of the inner conductive trace 501 of the intermediate layer is connected with the first end section of the conductive trace 504. The last end section of the conductive trace 504 of the upper layer is connected to the first end section of the inner conductive trace 507. The last end section of the second conductive trace 507 of the intermediate layer is connected with the second terminal electrode 511 through the conductive bridge 510 located in the lower layer.

For each conductive trace, one or two end sections, that is to say, the first and/or the last end section of the conductive trace are used to interconnect each of the conductive trace of one layer to the conductive trace of its adjacent layers via a pair of metal-filled via holes. Thus, the last end section of the outer conductive trace 501 of the intermediate layer is connected with the first end section of the conductive trace 504 of the upper layer via a pair of metal-filled via holes 502 and 503. The last end section of the conductive trace 504 of the upper layer is connected with the first end section of the inner conductive trace 507 of the intermediate layer via a pair of metal-filled via holes 505 and 506. The last end section of the inner conductive trace 507 of the intermediate layer is electrically connected to the conductive bridge 510 via a pair of metal-filled via holes.

Therefore, an electrical current that flows from the first terminal electrode 500, through the outer conductive trace 501 of the intermediate layer (the outer conductive spiral loop 5011), through a pair of metal-filled via holes 502, 503, through the conductive trace 504 of the upper layer (the outer conductive spiral loop 5041 and the inner conductive loops), through a pair of metal-filled via holes 505, 506, through the inner conductive trace 507 of the intermediate layer (the inner conductive spiral loop 5071), through a pair of metal-filled via holes 508, 509, finally through the conductive bridge 510 located in the lower layer, and flows out of the second terminal electrode 511. The winding may be used for making an inductor device and the like.

In this embodiment, the cross-sections of the pairs of metal-filled via holes dos not exceed the width a conductive trace.

### Embodiment 6

FIG. 8 shows plan views of the upper layer, the intermediate layer and the lower layer of the inductor winding at the left, and right sides respectively according to an embodiment. For each layout plan view, it includes the metal-filled via holes used for connecting a conductive trace of a layer to another conductive trace of its adjacent layer.

The inductor winding device comprises in total three conductive layers, named the upper layer, the intermediate layer, and the lower layer. The upper layer includes two conductive traces 601 and 607. The outer conductive trace 601 comprises a conductive spiral loop 6011, that is, the conductive trace 601 is a conductive spiral of one turn. The inner conductive trace 607 comprises two conductive spiral loops 6071 and 6072, that is, the inner conductive trace 607 is a conductive spiral of two turns. The intermediate layer includes two conductive traces 604 and 610. The outer conductive trace 604 comprises two conductive spiral loops 6041 and 6042, that is, the outer conductive trace 604 is a conductive spiral of two turns. The inner conductive trace 610 comprises a conductive spiral loop 6101, that is, the conductive trace 610 is a conductive spiral of one turn.

The three conductive spiral loops 6011, 6071 and 6072 of the upper layer have the same shape but different radius sizes, and are in a nested manner. The 3 conductive spiral loops 6041, 6042 and 6101 of the intermediate layer have the same shape but different radius sizes, and are in a nested manner. Finally, the lower layer contains a conductive bridge 613 that connects the inner conductive trace 610 (that is, the inner conductive spiral loop 6101) of the intermediate layer to a second terminal electrode 614. The conductive spiral loops are all square in shape; the inductor winding comprises in total six turns. Further, for the three adjacent layers, the spacing between two adjacent spiral loops of each layer is the same.

The outer conductive spiral loop 6011 of the upper layer is in face-to-face with the outer conductive spiral loop 6041 of the intermediate layer. The middle conductive spiral loop 6071 of the upper layer is in face-to-face with the middle conductive spiral loop 6042 of the intermediate layer. The inner conductive spiral loop 6072 is in face-to-face with the inner conductive spiral loop 6101 of the intermediate layer. Thus, the geometric center points of all the conductive spiral loops (O) are spatially aligned with each other.

Each conductive trace of one layer is electrically connected to the conductive trace of its adjacent layer. The first end section and/or the last end section of each conductive trace of one layer are connected to the first end section and/or the last end section of the conductive trace of its adjacent conductive layers via the metal-filled via holes, or connected to the terminal electrode via the conductive bridge.

The first end section of the outer conductive trace 601 of the upper layer is connected to the first terminal electrode 600. The last end section of the inner conductive trace 610 of the intermediate layer is connected to the second terminal electrode 614 through the conductive bridge 613 located in the lower layer.

For each conductive trace, one or two end sections, that is to say, the first or the last end section of the conductive trace, are used to interconnect each of the conductive trace of one layer to the conductive trace of its adjacent layers via a pair of metal-filled via holes. Thus, the last end section of the outer conductive trace 601 of the upper layer is connected with the first end section of the outer conductive trace 604 of the intermediate layer via a pair of metal-filled via holes 602 and 603. The last end section of the outer conductive trace 604 of the intermediate layer is connected with the first end section of the inner conductive trace 707 of the upper layer via a pair of metal-filled via holes 605 and 606. The last end section of the inner conductive trace 607 of the upper layer is connected with the first end section of the inner conductive trace 610 of the intermediate layer via a pair of metal-filled via holes 608 and 609. The last end section of the second conductive trace 610 of the intermediate layer is electrically connected with the conductive bridge 613 via a pair of metal-filled via holes 611 and 612.

Therefore, an electrical current that flows from the first terminal electrode 600, through the outer conductive trace 601 of the upper layer (the outer conductive spiral loop 6011), through a pair of metal-filled via holes 602 and 603, through the outer conductive trace 604 of the intermediate layer (the outer conductive spiral loop and the middle conductive spiral loop 6041 and 6042), through a pair of metal-filled via holes 605, 606, through the inner conductive trace 607 of the upper layer (the middle conductive spiral loop and the inner conductive spiral loop 6071, 6072), through a pair of metal-filled via holes 608 and 609, through the inner conductive trace 610 of the intermediate layer (the inner conductive spiral loop 6101), through a pair of metal-filled via holes 611 and 612, finally through the conductive bridge 613 located in the lower layer, and flows out of the second terminal electrode 614. The winding may be used for making an inductor device and the like.

In this embodiment, the cross-sections of the pairs of metal-filled via holes do not exceed the width a conductive trace.

### Embodiment 7

An inductive device includes a plurality of inductor windings described in the present invention, wherein each winding is connected together in series in order to form a single inductive device.

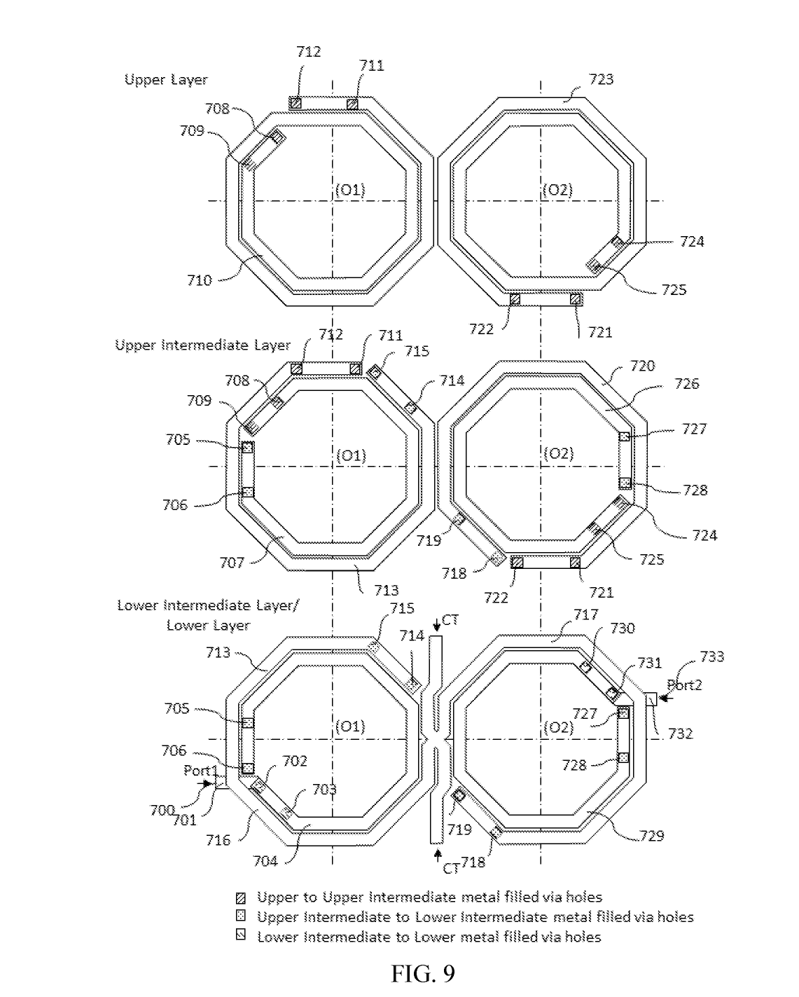

As shown in FIG. 9, the inductor device is formed by two inductor windings of the embodiment 3 which are rotated by 90° and −90°, respectively; the geometric central points of the two inductor windings (O1) and (O2) are shifted at the left and right side in such a way that the two inductor windings can be connected in series. Thus, the inductor device includes four layers and comprises ten conductive traces, twelve turns in total. The first and second terminal electrodes are located at the left inductor winding and the right inductor winding, respectively.

Due to the particular rotation of the two inductor windings, an electrical current flows from a first terminal electrode 700 at the left side follows the same direction as clockwise in the inductor winding of the left side and follows the contrary direction as anti-clockwise in the inductor winding of the right side. Thus, an electrical current that has accessed from the first terminal electrode 700 at the left side, flows through the first conductive bridge 701 located in the lower layer, through a pair of metal-filled via holes 702, 703, the inner conductive trace 704 of the lower-intermediate layer, through a pair of metal-filled via holes 705, 706, through the inner conductive trace 707 of the upper-intermediate layer, through a pair of metal-filled via holes 708, 709, through the conductive trace 710 of the upper layer, through a pair of metal-filled via holes 711, 712, through the outer conductive trace 713 of the upper-intermediate layer, through a pair of metal-filled via holes 714 and 715, through the outer conductive trace 716, flows into the inductor winding of the right side, through the outer conductive trace 717 of the lower-intermediate layer, through a pair of metal-filled via holes 718 and 719, through the outer conductive trace 720 of the upper-intermediate layer, through a pair of metal-filled via holes 721 and 722, through the outer conductive trace 723 of the upper layer, through a pair of metal-filled via holes 724 and 725, through the inner conductive trace 726 of the upper-intermediate layer, through a pair of metal-filled via holes 727 and 728, through the inner conductive trace 729 of the lower-intermediate layer, through a pair of metal-filled via holes 730 and 731, through the second conductive bridge 732 located in the lower layer, finally flows out of the second terminal electrode 733 at the right side.

Therefore, the electrical current induces a positive magnetic field in the inductor winding of the left side and a negative magnetic field in the inductor winding of the right side. As a result, the two inductor windings experience a positive mutual coupling and the total inductance value of the inductor winding may be improved; in addition, the inductor winding reduces significantly the mutual coupling with another second inductive device located nearby. Finally, a third terminal electrode can be connected in the middle of the two windings, so that the inductor winding can feature a center tap.

The inductor device can be used in an IC circuit, PCB circuit and the like.

### Embodiment 8

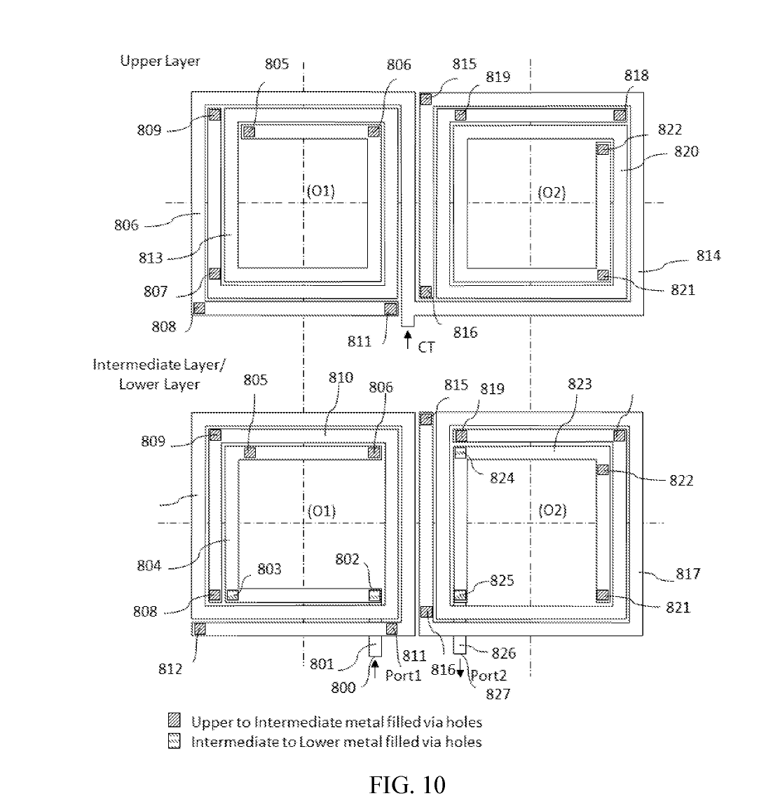

As shown in FIG. 10, the inductor winding is formed by two inductor windings of the embodiment 6 which are rotated by 90° and −90°, respectively. The geometric central points of the two inductor windings (O1) and (O2) are shifted at the left and right side in such a way that the two inductor windings can be connected in series. Thus, the inductor device includes three layers and comprises eight conductive traces, twelve turns in total. The first and second terminal electrodes are located at the inductor winding of the left side and the right side, respectively.

Because of the particular rotation of the two inductor windings, an electrical current accessing from a first terminal electrode 800 at the left side follows the same direction as clockwise in the inductor winding of the left side and follows the contrary direction as anti-clockwise in the inductor winding of the right side. Thus, an electrical current that has accessed from the first terminal electrode 800 at the left side, flows through the first conductive bridge located in the lower layer 801, through a pair of metal-filled via holes 802 and 803, through the inner conductive trace 804 of the intermediate layer, through a pair of metal-filled via holes 805 and 806, through the inner conductive trace 807 of the upper layer, through a pair of metal-filled via holes 808 and 809, through the outer conductive trace 810 of the intermediate layer, through a pair of metal-filled via holes 811 and 812, through the outer conductive trace 813 of the upper layer, flows into the inductor winding of the right side, through the outer conductive trace 814 of the upper layer, through a pair of metal-filled via holes 815 and 816, through the outer conductive trace 817 of the intermediate layer, through a pair of metal-filled via holes 818 and 819, through the inner conductive trace 820 of the upper layer, through a pair of metal-filled via holes 821 and 822, through the inner conductive trace 823 of the intermediate layer, through a pair of metal-filled via holes 824 and 825, through the second conductive bridge 826 located in the lower layer, finally flows out of the second terminal electrode 827.

Therefore, the electrical current induces a positive magnetic field in the inductor winding of the left side and a negative magnetic field in the inductor winding of the right side. As a result, the two inductor windings experience a positive mutual coupling and the total inductance value of the inductor winding may be improved. In addition, the inductor winding reduces significantly the mutual coupling with another second inductive device located nearby. Further, a third terminal electrode can be connected in the middle of the two windings, so that the inductor winding can feature a center tap.

It should be noted that, based on the description of embodiments, persons skilled in the art should understand that embodiments are only examples instead of limiting the present invention. In fact, the shape of the conductive loops may be other shapes. Further, the number of total turns is not limited to four, six or twelve, and other numbers, such as eight or sixteen, are also applicable. The conductive spiral loops are in a similar shape of square, blended square, octagon, polygon, circle or simple closed curve. The embodiments of inductor windings whose adjacent spiral loops are separated by the same spacing, or which conductive spiral loops feature same widths. In certain embodiment, the width of each conductive spiral loop can be inconstant. In order to improve the self-resonance frequency or the Q-factor, these parameters can be different. Further, in order to adjust the location of the first and second terminal electrodes along the winding, it is desirable to extend or reduce the length of the inner or outer conductive spirals which are connected to the terminal electrodes, such as reduce the length of the outer conductive trace of a fraction of one turn in order to match some layout requirements. Alternatively, the second terminal electrode can also be connected with the middle or inner loops via a conductive bridge, wherein the bridge can be located in an additional conductive layer. Alternatively, the bridge can be formed in a plurality of additional conductive layers in order to decrease the series resistance. Thus, it can be seen from the embodiments of each inductor winding used for constructing the inductive device according to an embodiment of the present invention features the following advantages:

As a consequence, the inductance value of the inductor is more than two times higher than a planar single-layer inductor winding consuming the same area and featuring the same number of turns, considering the magnetic mutual coupling effect between the adjacent loops.

The arrangement of the conductive spirals is made in that way that an electrical current that flows from the terminal electrode belong to an outer conductive trace, follows an alternate path from a upper conductive layer to an adjacent conductive layer or from a lower conductive layer to an adjacent conductive layer, and in a manner that the electrical current progressively flows from the outer conductive trace to the inner conductive trace, flows via the bridge and finally ends at another terminal electrode. As a consequence, the apparent parasitic coupling capacitance seen at the terminal electrodes is reduced compared to a multi-layer winding of the conventional technology and the performances, that are, the self-resonance frequency and the Q-factor are increased.

As the level of the electrical current flowing through the inductive winding is determined by the cross-sectional area of the conductor traces and of the metal-filled via holes, the width of the conductive traces can be adjusted in order to carry high level of electrical current.

The preparation method of a winding enables to assemble two inductor windings according to an embodiment of the present invention, wherein the two inductor windings are rotated by 90° and −90°, respectively, and electrically connected in series. Therefore the method for preparing a layout of an optimized multi-layer spiral inductor can be applied to construct low cross-coupling inductive devices.

An embodiment of the present invention further provides an inductive device comprising the either inductor winding.

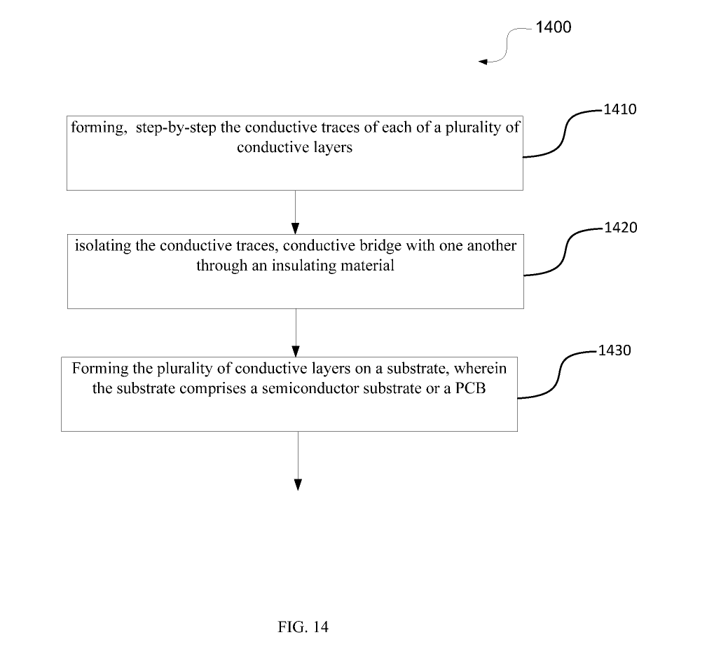

FIG. 14 is a flow chart illustrating a method of preparing a multi-layer spiral inductor winding in consistency with an embodiment of the invention.

An embodiment of the present invention further discloses a preparation method of an inductor winding, at least comprising: forming, in block 1410, step-by-step the conductive traces of each of a plurality of conductive layers, isolating, in block 1420, the conductive traces, conductive bridge with one another through an insulating material, and forming, in block 1430, the plurality of conductive layers on a substrate, wherein the substrate comprises a semiconductor substrate, an isolating material or a PCB.

Therefore, based on the description of the embodiments, those skilled in the art should understand that the above descriptions are only examples instead of limiting the present invention. In fact, any windings having the following features are included in the scope of the present invention:

An inductor winding comprises a plurality of conductive layers, each conductive layer of a plurality of conductive layers includes at least one conductive trace, each conductive trace can be a conductive spiral of one or two turns or a fraction of one turn; an additional conductive layer which includes a conductive trace, that is, a conductive bridge, wherein the conductive bridge is configured to connect the conductive trace to the terminal electrodes. Optionally, the winding can include a plurality of additional conductive layers instead of an additional conductive layer, wherein each of the plurality of additional layers can include a conductive section trace, each of the conductive section traces is isolated by an insulating material; and the conductive section traces are placed in parallel, respectively; and each conductive section trace is electrically connected to each other using metal-filled via holes in order to form one conductive bridge.

An embodiment of the present invention further provides an inductive device comprising: a plurality of inductor windings as describe above, wherein each winding is connected together in series in order to form a single inductive device.

An embodiment of the present invention further provides a preparation method of an inductor winding, at least comprising:

Forming the conductive traces or the conductive bridges of each conductive layer step-by-step, wherein the conductive traces are isolated with one another using an insulating material, wherein the substrate comprises a semiconductor substrate, an isolating material or a PCB.

### DESCRIPTION OF TECHNICAL PRINCIPLES

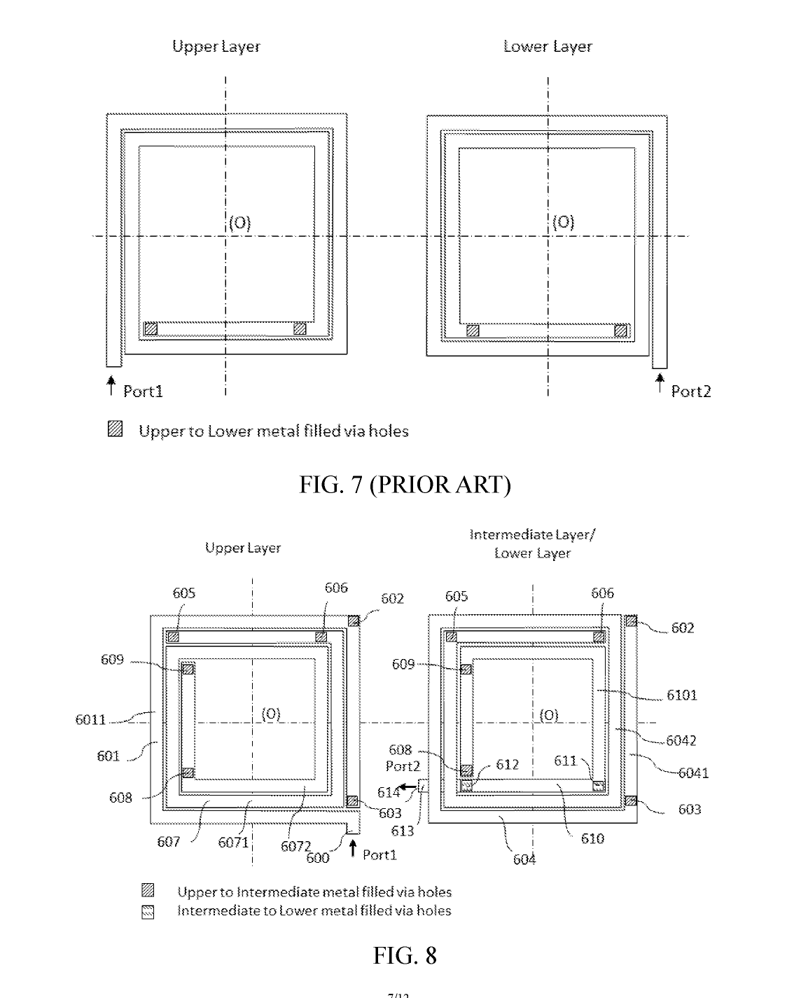

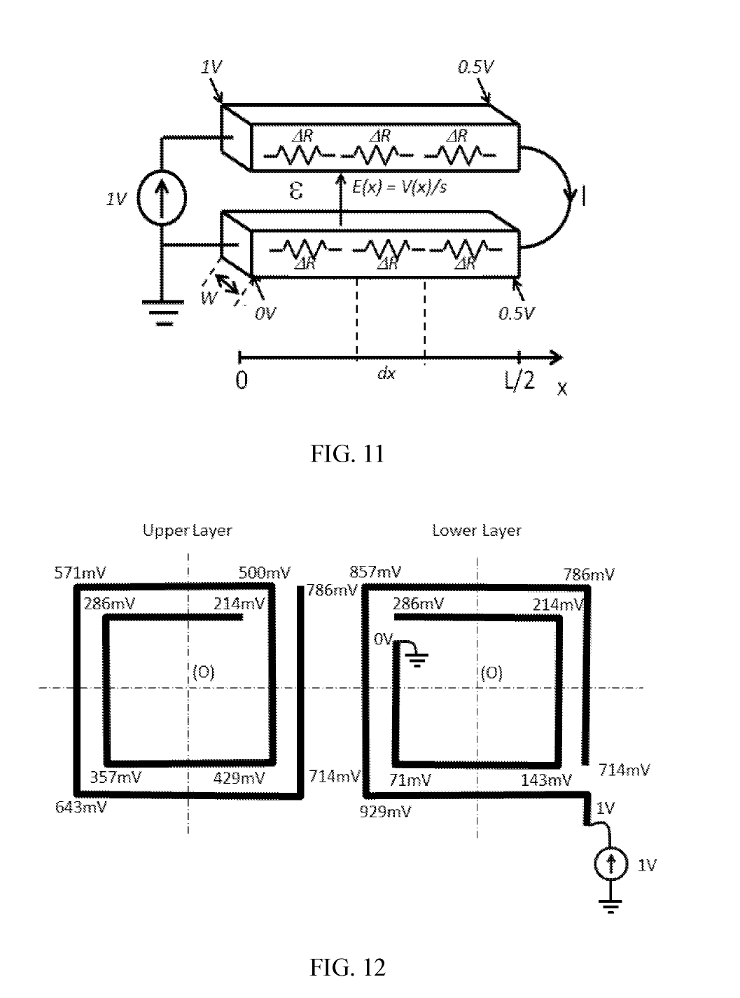

To better understand the advantages of an embodiment of the present invention, detailed studied on the parasitic coupling capacitance of the conductive loops are shown in FIGS. 6, 7, with reference to the FIGS. 11, 12 and 13 illustrating the circuit theory of embodiment of the invention as follows.

As shown in FIG. 11, assume two ideal, uniform and conductive lines set in face-to-face and shorted at the right extremity which the two lines are separated by an insulating material of thickness s and dielectric constant E, and the length of each line is L/2. The width of the each line is W. Assume that the lines are purely resistive and the distribution of the resistance is uniform along the lines. This results to the linear distribution of the potential along the line. At the left side, the differential voltage between the lines is 1V whereas at the right side, the differential voltage is 0V. The differential voltage across the two lines V(x) as function of the position x can be expressed as following:

$$V ( x ) = - \frac{2 \cdot x}{L} + 1 \qquad ( 1 )$$

Neglecting the fringing capacitances, the capacitance value dC of a section of line dx can be expressed as following:

$$dC = \frac{ɛ \cdot W}{s} \cdot dx \qquad ( 2 )$$

The amount of electric energy stored by the lines Ec can be expressed as the sum of the capacitances of all the sections and the differential voltage along the line:

$$\begin{matrix}Ec = \frac{1}{2} \cdot C \cdot {V}^{2} = \frac{1}{2} {\int }_{0}^{L \text{/} 2} dC \cdot {V ( x )}^{2} d \\ or , & ( 3 ) \\ Ec = \frac{1}{2} \cdot \frac{ɛ \cdot W}{s} \cdot \frac{L}{6} & ( 4 )\end{matrix}$$

Then, the equivalent capacitance C_{EQ} seen at the input terminals can be expressed as the following:

$${C}_{EQ} = \frac{ɛ \cdot W}{s} \cdot \frac{L}{6} ∼ 0.333 \cdot {C}_{f 2 f} \qquad ( 5 )$$

where C_{f2f} is the capacitance value corresponding to the parallel plate capacitance when the lines are opened at the right extremity

$${C}_{f 2 f} = \frac{ɛ \cdot W}{s} \cdot \frac{L}{2} \qquad ( 6 )$$

From above description, assume the inductor winding in accordance with our present invention, shown in FIGS. 6 and 12. Assume at first assumption that the inner and the outer conductive loops have ideally the same length. When a voltage of 1V is applied to the inductor winding, the differential voltage between the outer conductive loop of the upper layer and the outer conductive loop of the lower layer is constant and is equal to 0.285V. Similarly, the differential voltage between the inner conductive loop of the upper layer and the inner conductive loop of the lower layer is constant and is equal to 0.285V.

The electric energy stored by the winding and related to the two adjacent layers can be expressed as following (the electric energy stored by the loops in a nested manner is not considered because the separation distance can vary and then be optimized)

$$\begin{matrix}Ec ∼ \frac{1}{2} \cdot {C}_{f 2 f} \cdot {0.285}^{2} \\ where & ( 7 ) \\ {C}_{f 2 f} = \frac{ɛ \cdot W}{{t}_{{IMD}_{1}}} \cdot 6 \cdot {L}_{section} \\ and & ( 8 ) \\ L = 14 \cdot {L}_{section} & ( 9 )\end{matrix}$$

where W is the loop width, L is the total length of the unwound winding, L_{section} is the average length of a section of the loop, t_{IMD1} is the thickness of the inter-metal dielectric (IMD) corresponding to the separation distance of the outer loop of the upper layer and the outer loop of the lower layer, which is also the distance between the inner loop of the upper layer and the inner loop of the lower layer. Note that generally t_{IMD1} is fixed by the technological process and usually feature thin value. Therefore, the equivalent capacitance related to the face-to-face coupling capacitance of the inductor can be expressed as following:

$${C}_{EQ} ∼ 0.035 \cdot \frac{ɛ \cdot W \cdot L}{{t}_{IMD 1}} \qquad ( 10 )$$

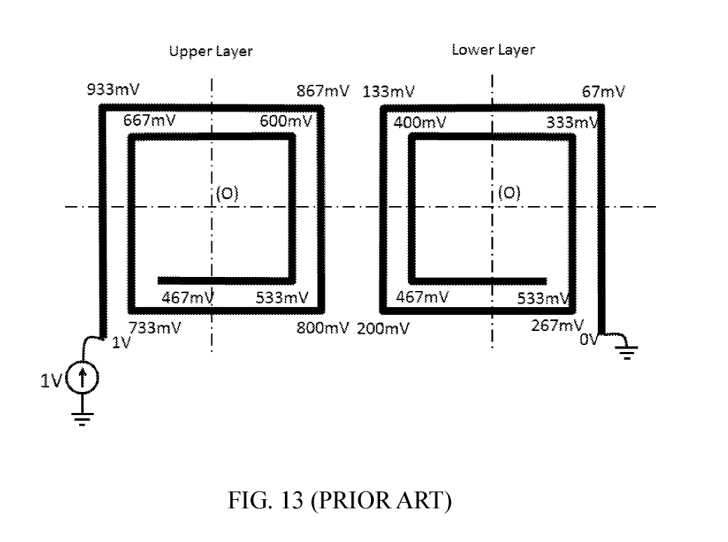

Now, assume the conventional inductor winding shown in FIGS. 7 and 13. When a voltage of 1V is applied to the inductor winding, the differential voltage between the outer conductive loop of the upper layer and the outer conductive loop of the lower layer is equal to 0.8V and 0.533V, respectively at the top side and bottom side. The differential voltage between the inner conductive loop of the upper layer and the inner conductive loop of the lower layer is equal to 0.266V.

The electric energy stored by the winding and related to the two adjacent layers can be expressed as following

$$\begin{matrix}Ec ∼ \frac{1}{2} \cdot {C}_{f 2 f} \cdot ( 3 \cdot {0.8}^{2} + 1 \cdot {0.533}^{2} + 3 \cdot {0.266}^{2} ) \\ where & ( 11 ) \\ {C}_{f 2 f} = \frac{ɛ \cdot W}{{t}_{{IMD}_{1}}} \cdot 7 \cdot {L}_{section} \\ and & ( 12 ) \\ L = 15 \cdot {L}_{section} & ( 13 )\end{matrix}$$

Therefore, the equivalent capacitance related to the face-to-face coupling capacitance between two layers of the inductor can be expressed as the following

$${C}_{EQ} ∼ 0.161 \cdot \frac{ɛ \cdot W \cdot L}{{t}_{IMD 1}} \qquad ( 14 )$$

Comparing with the conventional layout as shown in FIG. 6, the coupling capacitance in the present embodiment can be obviously reduced, thus the self-resonance frequency (fSR) as shown in the following can be obviously increased and the performances greatly improved. Moreover, one can demonstrate that by increasing the number of loops of the inductor windings or by increasing the number of layers, it leads to widen the values of the face-to-face coupling capacitance between the inductor winding in accordance with the an embodiment of present invention and the conventional multi-layer inductor winding.

$${f}_{SR} = \frac{1}{2 π \sqrt{{L}_{S} {C}_{P}}} \qquad ( 15 )$$

where Ls is the inductance value of the winding and Cp is the total coupling capacitance that includes the capacitance related to the face-to-face loops and to the adjacent loops located in a same layer.

The peak Q-factor is as a consequence improved.

$${Q}_{Peak} = \frac{2}{3 \sqrt{3}} \cdot \frac{{L}_{S} \cdot 2 π {f}_{SR}}{{R}_{S}} \qquad ( 16 )$$

Considering same total length of the unwound winding, we demonstrate that the parasitic coupling capacitance between the conductive loops of the upper layer and the conductive loops of the lower layer for the present embodiment, shown in FIG. 6, is smaller than the parasitic coupling capacitance between the conductive loops of the upper layer and the conductive loops of the lower layer for the conventional inductor winding, shown in FIG. 7.

Therefore, an embodiment of the present invention effectively overcomes defects in the conventional technology and has high industrial utilization value.

The above descriptions of the detailed embodiments are only to illustrate the principle and the efficacy of the present invention, and it is not for limiting the scope of the present invention. Any person skilled in the art can modify or change the embodiments without departing from the spirit and scope of the present invention. Accordingly, all equivalent modifications and variations completed by persons of ordinary skill in the art, without departing from the spirit and technical idea of the present invention, should fall within the scope of an embodiment of the present invention defined by the appended claims.

What is claimed is:

1. A multi-layer spiral inductor winding comprising:
a plurality of conductive layers, wherein each of the plurality of conductive layers include a plurality of conductive traces, and wherein each conductive trace comprises a conductive spiral of at least a fraction of one turn, and wherein at least one conductive trace of the plurality of conductive traces comprises a conductive spiral of two turns;
an additional conductive layer, wherein the additional conductive layer includes a conductive trace, and wherein the conductive trace comprises a conductive bridge, and wherein the conductive bridge is configured to connect a second terminal electrode of the inductor winding to a conductive trace of the plurality of conductive layers;
wherein a first terminal electrode of the inductor winding belongs to another conductive trace of the plurality of conductive layers; and wherein each of the conductive traces is isolated by an insulating material, and each conductive trace is electrically connected to a conductive trace of an adjacent conductive layer to form an inductor winding; and
wherein an electrical current passes from a first terminal electrode connected to an outer conductive trace, into the conductive layer of the outer conductive trace, to a first adjacent layer of the conductive layer, to a second adjacent layer of the first adjacent layer, at last to a first terminal electrode to the inner conductive trace connected to the conductive bridge, and flows out of a second terminal electrode connected to the conductive bridge.

2. The multi-layer spiral inductor winding as in claim 1, wherein the winding includes a plurality of additional conductive layers including the additional conductive layer, wherein each of the plurality of additional layers includes a conductive section trace, each of the conductive section traces is isolated by an insulating material; and wherein the conductive section traces are placed in parallel with each other; and wherein each conductive section trace is electrically connected to one another using metal-filled via holes.

3. The multi-layer spiral inductor winding as in claim 2, wherein the conductive trace connected to the conductive bridge is an inner conductive trace of the multi-layer spiral inductor winding and is a spiral of at least a fraction of one turn.

4. The multi-layer spiral inductor winding as in claim 2, wherein the conductive trace connected to the conductive bridge is an outer conductive trace of the multi-layer spiral inductor winding and is a spiral of at least a fraction of one turn.

5. The multi-layer spiral inductor winding as in claim 2, wherein the conductive trace connected to the first terminal electrode is an outer conductive trace of the multi-layer spiral inductor winding and is a spiral of at least a fraction of one turn.

6. The multi-layer spiral inductor winding as in claim 1, wherein each conductive trace of the plurality of conductive layers is electrically connected to one another at its one end section or both end sections using metal-filled via holes to form a multi-layer spiral inductor winding.

7. The multi-layer spiral inductor winding as in claim 1, wherein the geometric central point of each conductive spiral of the winding is spatially aligned with one another.

8. The multi-layer spiral inductor winding as in claim 1, wherein each conductive spiral is formed using a shape of square, blended square, octagon, polygon, circle or simple closed curve.

9. A multi-layer spiral inductive device comprising:
a plurality of multi-layer spiral inductor windings as in claim 1, wherein each of the plurality of multi-layer spiral inductor windings is connected together in series to form a single multi-layer spiral inductive device.

10. A preparation method of a multi-layer spiral inductor winding, comprising:
forming step-by-step the conductive traces of each conductive layer,
isolating the conductive traces with one another using an insulating material, and
forming the multi-layer spiral inductor winding on a substrate, wherein the substrate comprises a semiconductor material, an isolating material or a multi-layer Printed Circuit Board (PCB).
